(19) United States
(12) Patent Application Publication
(10) Pub. No.: US 2011/0297601 A1
(43) Pub. Date: Dec. 8, 2011

(54) PHYSICAL WATER PURIFIER

(76) Inventors: Wolfgang Spier, Porta Westfalica (DE); Friedrich-Wilhelm Schmeding, Porta Westfalica (DE)

(21) Appl. No.: 12/306,962

(22) PCT Filed: Jul. 4, 2007
(86) PCT No.: PCT/EP07/56721

§ 371 Date: Aug. 25, 2011

(30) Foreign Application Priority Data
Jul. 5, 2006 (DE) 20 2006 010 400.3

(51) Int. Cl. C02F 1/48; C02F 1/68

(52) U.S. Cl. 210/199; 210/222

(57) ABSTRACT

A physical water purifier includes a tubular housing and permanent magnets arranged at a specific distance from one another in the tubular housing in a region of the tubular housing facing a water connection. The permanent magnets are arranged so as to form a pumping and eddying effect. The permanent magnets are produced from an anisotropic magnetic material.

### CROSS-REFERENCE TO RELATED APPLICATIONS

This application is a National Phase Application based upon and claiming the benefit of priority to PCT/EP2007/056721, filed on Jul. 4, 2007, which is based upon and claims the benefit of priority to German Patent Application No. DE 20 2006 010 400.3, filed on Jul. 5, 2006, the contents of both of which are incorporated herein by reference.

### BACKGROUND AND SUMMARY

The present disclosure relates to a physical water purifier with a tubular housing.

It is generally known that spring water is of the highest possible quality, since it has a high content of dissolved carbons and minerals. This extremely healthy and vital state is manifested by a shimmering, luminescent blue color, which is no longer the case with water of lower quality. This water would be ideal for drinking, but unfortunately is not available to consumers. Furthermore, on account of environmental changes, today there are only very few remaining springs of high quality.

To supply water, the water flows under high pressure through straight water pipelines. The water is therefore denatured by further ways in which it is unnaturally treated. One of the consequences is the externally detectable mineral deposits and another is that the water lacks internal energy. That is, it no longer has sufficient power of self defense to stop it retaining information from harmful substances and no longer tastes as refreshing as spring water. In a spring, the water flows unrestrictedly over hill and dale, as it were, forms natural vortices and whirlpools and flows in a meandering form alternately from left to right and, in particular, not in a straight direction.

The present disclosure relates to a physical water purifier in the form of a multichamber water recovery unit which produces water of a quality that is healthy for man, animals, plants and the soil. Furthermore, problems resulting from contamination due to microbial growth, bacteria and algae are at least noticeably reduced. To improve the quality of the water, it is intended to dispense with the addition of chemical agents or the use of electricity, so that the water is brought into a hygienic state and boosted in its own powers of defense by natural means, while the valuable minerals taken up from the natural environment are nevertheless retained.

The water purifier, according to the present disclosure, includes permanent magnets and/or precious stones and/or a colloidal medium arranged inside the housing of the water purifier.

According to the present disclosure, a multichamber water recovery unit is achieved. The permanent magnets have the effect that relatively unrefined external active forces are exerted on the water by permanently magnetic force fields, causing the water to be stirred up. Furthermore, a vortexing motion of the water is brought about. The precious stones and the colloidal medium, which may also be provided, have the effect that the water is subjected to finer external active forces, a transfer of oscillations energizing the water and freeing it of information from harmful substances. This achieves the effect of killing off germs, bacteria and algae. Furthermore, the internal, finest forces of the water itself are used, providing the vortexing whirlpool motion of the water. The individual effects are also achieved by the introduced elements on their own. It, however, the water purifier is equipped with the combination, the advantages are achieved altogether.

The physical water purifier operates on the throughflow principle. The housing is provided with a water connection at one end and with a water outlet at the opposite end.

To form a pumping and eddying effect, permanent magnets arranged at a specific distance from one another and are inserted in the region of the chamber that is facing the water connection. These permanent magnets may be formed as disk magnets, ring magnets or bar magnets.

In order to produce turbulence in the water, water baffle spacers are inserted between the permanent magnets in the housing. As a result, the water is stirred up and decompressed. To achieve this, the water baffle spacers are provided on the outer region with clearances. The water baffle spacers may be produced from a suitable, resistant material, for example from brass or unplasticized PVC.

It is advantageous if the permanent magnets are arranged in a differently polarized manner. As a result, strong turbulence is produced in the water, which is important in particular for the decompression of the water. Furthermore, the atomic shell of the calcium can be magnetically influenced such that, finally, calcium is created in a crystalline form, from the aragonite crystal, such as limestone, that is difficult to remove, to the calcite crystal, lime powder, that is easily detached.

In an embodiment, according to the present disclosure, the permanent magnets are produced from anisotropic magnetic materials, since these are also corrosion-resistant.

It is also provided that water baffle spacers are arranged between the permanent magnets in the housing. In an embodiment according to the present disclosure, each water baffle spacer is formed in the manner of a disk, the outer region comprising peripheral segments, the widths of which are greater than the middle region. As a result, the distance between the permanent magnets is precisely defined.

At this point, it should be noted that the magnet chamber is fitted with a number of permanent magnets and water baffle spacers of very different types. This cascade type of arrangement brings about important pumping and eddying effects, as encountered in the run of a natural stream.

In another embodiment according to the present disclosure, to form a water flow rotating to the right, the water baffle spacer is provided with arcuate vanes in the outer region, both from the inside to the outside, and from the outside to the inside. The arrangement of the vanes corresponds to the natural pitch of the DNS spiral. This embodiment predetermines the direction of flow of the water, which may be from the inside outward and from the outside inward. In addition, the flow velocity of the water can be changed, i.e., the water flow can be speeded up or slowed down. In addition, further turbulence effects are produced on the water, so that the course of a natural mountain stream is replicated. The water baffle spacers are also designed in such a way that the water flow is given a right-handed twist. A right-handed rotation of the water is accepted much better by the body of a human or an animal than water flowing with a left-handed twist, since the body is made up of dextrorotary molecules and any levorotary molecule is perceived as a foreign body.

Furthermore, restricted guidance is achieved in that all the water molecules have to flow over the complete surfaces of the inner sides of the permanent magnets. In addition, the so-called water clusters are broken up, whereby higher water solubility is achieved. According to another embodiment of the present disclosure, each water baffle spacer may be provided in the outer region of its periphery with semicircular clearances. In the case of this embodiment, the outer region may also be provided with a number of spacers, which may be respectively provided with a peripheral annular groove in order to fix them on the water baffle spacer. According to a further embodiment of the present disclosure, a number of water baffle spacers may form an assembly, the individual water baffle spacers being at an acute angle in relation to one another. For the two last-mentioned embodiments of the water baffle spacers, the advantages already mentioned herein are achieved. For the water to accept further information, it is also provided that one or more glass disks, which are provided with apertures and/or symbols and the like, are additionally provided inside the housing.

Materials that are approved for the supply of drinking water and do not lead to corrosion may be used for the water baffle spacers. Such materials are grades of stainless steel, nonferrous metals, gold, silver and sintered materials and plastics that are suitable for injection molding processes. In addition, ceramic materials may also be used. Combinations of metals, plastics and ceramic materials are also possible.

In a further embodiment of the present disclosure, it is provided that, adjoining the chamber having the permanent magnets, a crystal-colloid chamber is provided in the form of a double chamber. Precious stones and a colloidal medium, such as, for example, silver, are introduced into this crystal-colloid chamber. In another embodiment according to the present disclosure, the colloidal medium is facing toward the permanent magnets and the precious stones are accordingly facing away from the permanent magnets. If a colloidal solution is concerned, the concentration can be changed. The precious stones serve for revitalizing the water and the colloidal medium serves for reducing germs. The precious stones pass on to the water the energizing, life-building and cleaning oscillations, so that the quality of the water is equivalent to the quality of spring water. The colloidal medium leads not only to disinfection of the water, but also to its fortification. As a result, medical significance is also achieved, in that the natural immune system is supported. The effect is based primarily on silver ions, which impair the energy extraction of bacteria and fungus cells in that their cytochrome system is interrupted. As a result, these germs suffocate within a few minutes, since they lose liquid and electrolytes and dry and shrink as a result. In a further embodiment according to the present disclosure, it is provided that the dimensions of the crystal-colloid chamber correspond to the generally known golden section, i.e., the diameter to the length of the chamber corresponds to the ratio of 1 to 1.618 or else, in inverse ratio, 1.618 to 1.

The golden section is another name for the ratio that is known as the phi quotient and is mathematically determined exactly by a known formula. The choice of dimensions in accordance with the golden section is based on the finding that life always develops itself in accordance with this mathematical formula or the precise relationships between the dimensions. The unending reproduction of the water of life and the waters of light is only possible thanks to the quotients pi and phi, and these waters also restore the harmony of the conditions in the body. Phi quotient mathematics runs not only through the entire human spectrum but through the entire spectrum of all known organic structures.

In order that the right-handed rotation of the water flow passing through is also ensured in the region of the crystal-colloid chamber, the crystal-colloid chamber is surrounded by spiral grooves rotating to the right. These spiral grooves may be formed in generally known cross sections.

It is also provided, according to the present disclosure, that either these spiral grooves rotating to the right are provided on the inside of a sleeve which is inserted into the housing via the crystal-colloid chamber, or else it is possible that the spiral grooves are incorporated directly on the inside of the housing. It should also be mentioned that the spiral grooves rotating to the right do so in relation to the direction of throughflow of the water. It is also provided, according to the present disclosure, that the crystal-colloid chamber is followed by a funnel. This funnel may be designed in various configurations, but geometrical forms, such as, for example, the form of a cone or a hyperbola or a sphere, may be advantageous.

The funnel is designed such that an inwardly rolling, vortexing motion of the water flow is achieved, further supported by a groove turning to the right that is incorporated on the inner side of the funnel.

Again, non-corrosive materials, such as, for example, nonferrous metals or unplasticized PVC, come into consideration as materials. Alternatively, however, the housing may also be formed in the manner of a funnel at the region adjacent the crystal-colloid chamber. In this case, the forms already mentioned herein again come into consideration.

In a further embodiment according to the present disclosure, it is also provided that the funnel and the housing are embodied in their outer dimensions in accordance with the ratio of the so-called golden section. For example, the respective diameter to length corresponds to the ratio 1 to 1.618 and variably also inversely 1.618 to 1. Depending on the capacity requirements, however, the dimensions may also deviate from this. If required, the individual components described above may also be accommodated in multiple arrangement in a common housing.

It is within the scope of the present disclosure that the production of the physical water purifier may also be modular or it may be put together in the manner of a kit, in order to adapt it in a way corresponding to the respective water purification in situ. It is also within the scope of the present disclosure to dispense with the crystal-colloid chamber or the permanent magnets and to dispense with the water baffle spacers and the funnel.

The physical water purifier, according to the present disclosure, may also be designed in such a way that basic sterilization can be achieved by different variants. For instance, it may be provided that the sterilizing module is additionally flange-mounted after the run-out region. The run-out funnel may be conically formed and include copper or silver. Alternatively, it is also within the scope of the present disclosure for the inner surface of the run-out funnel to have a coating of copper or silver. The sterilizing module may be designed in such a way that it operates on the transverse or longitudinal principle, i.e., the effective surfaces are transverse to the direction of flow of the water or in the direction of flow of the water. It is also within the scope of the present disclosure for the sterilizing module operating on the longitudinal principle to comprise clustered silver or copper tubes and a copper or silver coating of the run-out funnel. In addition, the sterilizing module may be externally arranged and act on the longitudinal principle and also comprise a rolled-up silver mat and a run-out funnel made of copper.

By conducting the water in a specifically outward-to-inward hyperbolic manner, the sterilizing module produces a cyclone-like eddying effect in which there is a natural flow. Such a manner or effect can optionally be taken away, and a levitating water flow can be produced from the inner lower region to the outer upper region and again the desired pumping and eddying effect can be achieved by this geometrical shaping that tapers from the bottom upward and ends in an opening oval form, such as, for example, the cross section of a trout's body.

Other aspects of the present disclosure will become apparent from the following descriptions when considered in conjunction with the accompanying drawings.

### BRIEF DESCRIPTION OF THE DRAWINGS

FIG. 1 shows a longitudinal section of a physical water purifier, in accordance with the present disclosure.

FIG. 2 shows an embodiment of a permanent magnet with a water baffle spacer in a sectional view, in accordance with the present disclosure.

FIG. 3 shows a first embodiment of a water baffle spacer in an elevational view, in accordance with the present disclosure.

FIG. 4 shows the water baffle spacer, according to FIG. 3, in an end elevational view.

FIG. 5 shows a second embodiment of a water baffle spacer in an end elevational view, according to the present disclosure.

FIG. 6 shows the water baffle spacer, according to FIG. 5, in a side elevational view.

FIG. 7 shows a third embodiment of a water baffle spacer in a side elevational view, in accordance with the present disclosure.

FIG. 8 shows the water baffle spacer, according to FIG. 7, in an end elevational view.

FIG. 9 shows a fourth embodiment of a water baffle spacer in a side elevational view, in accordance with the present disclosure.

FIG. 10 shows the water baffle spacer, according to FIG. 9, in an end elevational view.

FIG. 11 shows an information glass disk in a side elevational view, in accordance with the present disclosure.

FIG. 12 shows the information glass disk, according to FIG. 11, in an end elevational view.

FIG. 13 shows a crystal-colloid chamber in longitudinal section, in accordance with the present disclosure.

FIG. 14 shows the crystal-colloid chamber, according to FIG. 13, in an end elevational view.

FIG. 15 shows a tubular sleeve, for fixing a crystal-colloid- chamber, in longitudinal section, in accordance with the present disclosure.

FIG. 16 shows an end elevational view corresponding to FIG. 15.

FIG. 17 shows a copper spiral spring, for fixing a crystal-colloid chamber, in longitudinal section, in accordance with the present disclosure.

FIG. 18 shows an end elevational view corresponding to FIG. 17.

FIG. 19 shows a further embodiment of a crystal-colloid chamber with an attached funnel, in accordance with the present disclosure.

FIGS. 20 to 22 show three different embodiments, of a run-out funnel, in accordance with the present disclosure.

FIG. 23 shows a sterilizing module inserted in a housing and externally added on, in accordance with the present disclosure.

FIG. 24 shows a further embodiment of a sterilizing module, in accordance with the present disclosure.

FIG. 25 shows another embodiment of a sterilizing module, in accordance with the present disclosure.

### DETAILED DESCRIPTION

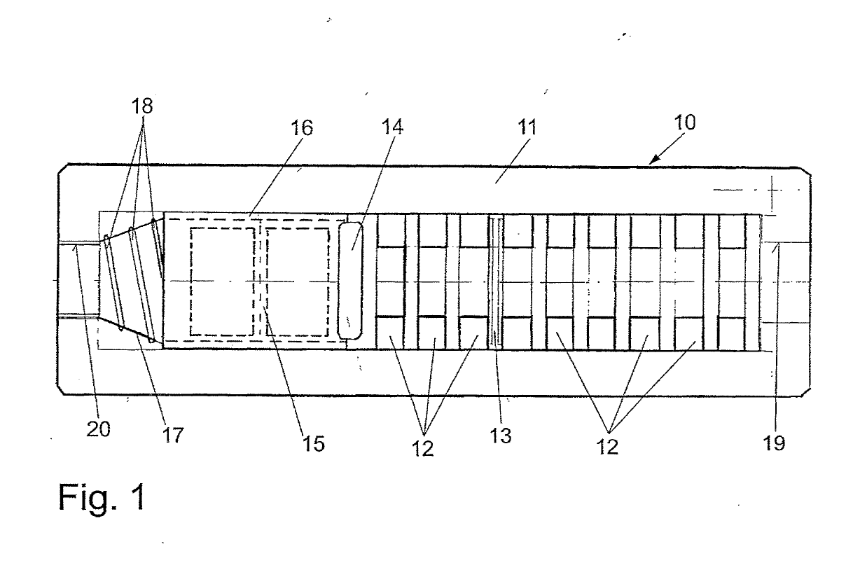

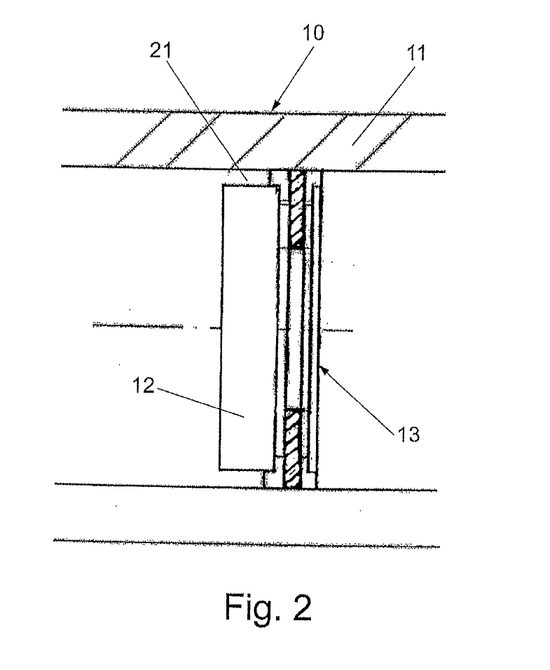

A physical water purifier 10, as shown in FIG. 1, comprises a tubular housing 11 of a corrosion-resistant material in which permanent magnets 12 are inserted and kept at a distance from one another by water baffle spacers 13. For simplified representation, only one water baffle spacer 13 is depicted, and is shown in various embodiments in FIGS. 2 to 10. The region of the permanent magnets 12 is adjoined by an information-bearing glass disk 14, as also shown in FIGS. 11 and 12. This is followed by a double chamber, for example, crystal-colloid chamber 15. The crystal-colloid chamber 15 is outwardly bounded, for example, by an inserted sleeve 16. This is adjoined by a run-out funnel 17, which is provided, with reference to the water flow running through, with directing grooves 18 rotating to the right. At an end facing the permanent magnets 12, the tubular housing 11 is provided with a water connection 19, which is formed by a thread. A tube nipple, for example, may be screwed into the water connection (not shown). At the opposite end, the housing 11 is provided with a corresponding water outlet 20.

In the embodiment that is shown in FIG. 1, the permanent magnets 12 are ring magnets. By contrast, the permanent magnets 12 may also be in the form of bars or disks.

In an embodiment shown in FIG. 2, the permanent magnets 12 are formed in the manner of disks. Between an inner surface of the housing 11 and an outer surface of each permanent magnet 12, there is an annular gap 21. Each permanent magnet 12 is held by a water baffle spacer 13, which has a bore and is provided on the circumference with clearances. Each water baffle spacer 13 is provided on both sides with a machined hollow, in which the adjacent permanent magnet 12 is inserted.

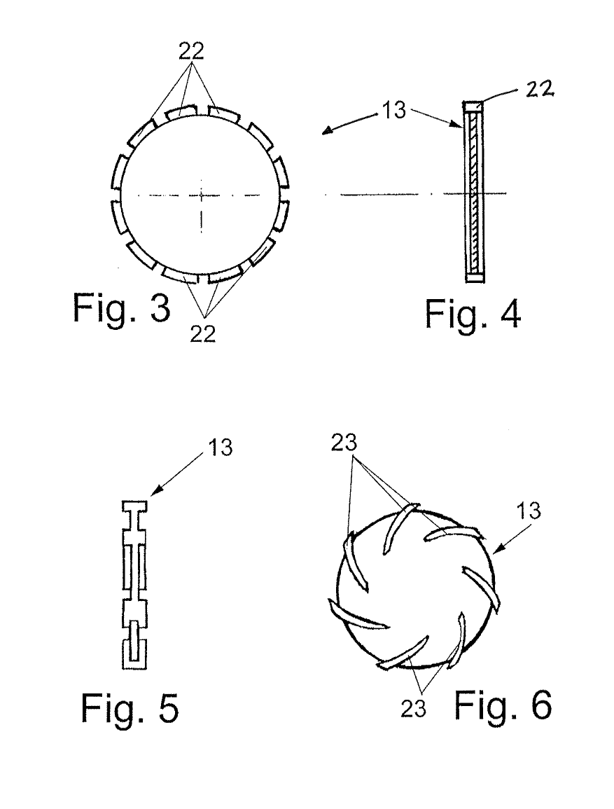

The water baffle spacer 13, as shown in FIGS. 3 and 4, is formed in the manner of a disk and is provided at the circumference with a multiplicity of segments 22, so that the water can flow through gaps between the segments 22. As shown in FIG. 4, the segments 22 are wider than the disk, so that the distance between two annular permanent magnets 12 is predetermined by the width of the segments 22.

The water baffle spacer 13, as shown in FIGS. 5 and 6, is provided on the outer circumference with arcuately extending vanes 23. This embodiment allows the flow velocity of the water to be changed, i.e., the water flow can be speeded up or slowed down. Furthermore, the water flow is made turbulent, to simulate the course of a natural mountain stream. The predetermined geometry of the water baffle spacer 13 has the effect that right-turning information is always imparted to the water flowing through, both from the inside to the outside and from the outside to the inside. The arrangement of the vanes 23 corresponds to the natural pitch of the DNS spiral. Here too, the golden section is reproduced.

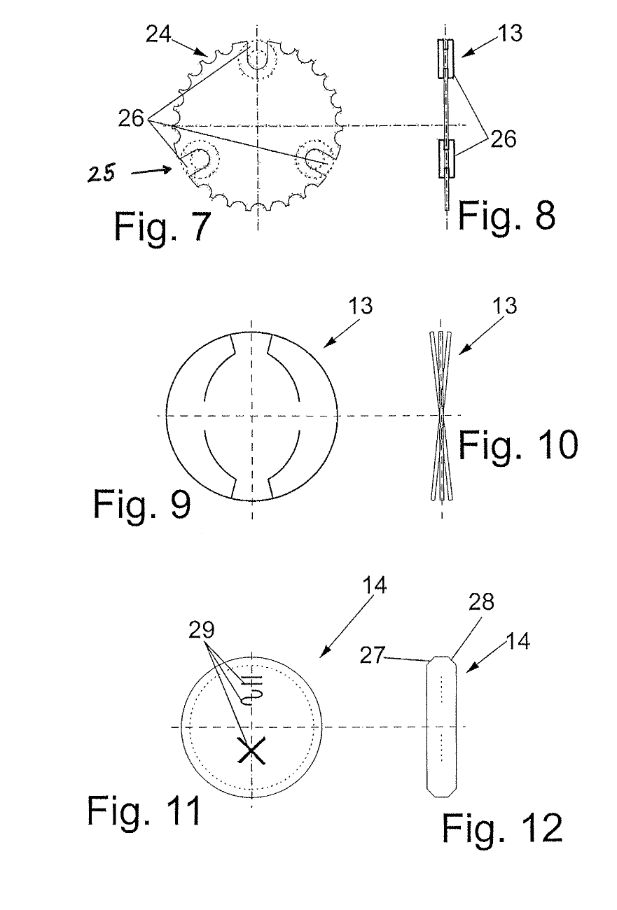

The water baffle spacer 13, as shown in FIGS. 7 and 8, is provided on the outer side with semicircular clearances 24, through which the water can flow. Furthermore, it is provided with U-shaped clearances 25, inserted in which are spacers 26, which are provided with peripheral annular grooves in which the water baffle spacer 13 engages.

The water baffle spacer 13, as shown in FIGS. 9 and 10, comprises an assembly formed by three disks. The two outer disks are at an angle to the middle disk, so that the two outer disks are in the form of an X in relation to one another.

FIGS. 11 and 12 show the information-bearing disk 14 produced from glass, which, as shown in FIG. 1, is inserted in the housing 11 between the region of the permanent magnets 12 and the crystal-colloid chamber 15. On both sides, the disk 14 is provided with bevels 27, 28. The disk 14 is also provided with a number of information symbols 29, which may deviate from that shown in FIG. 11.

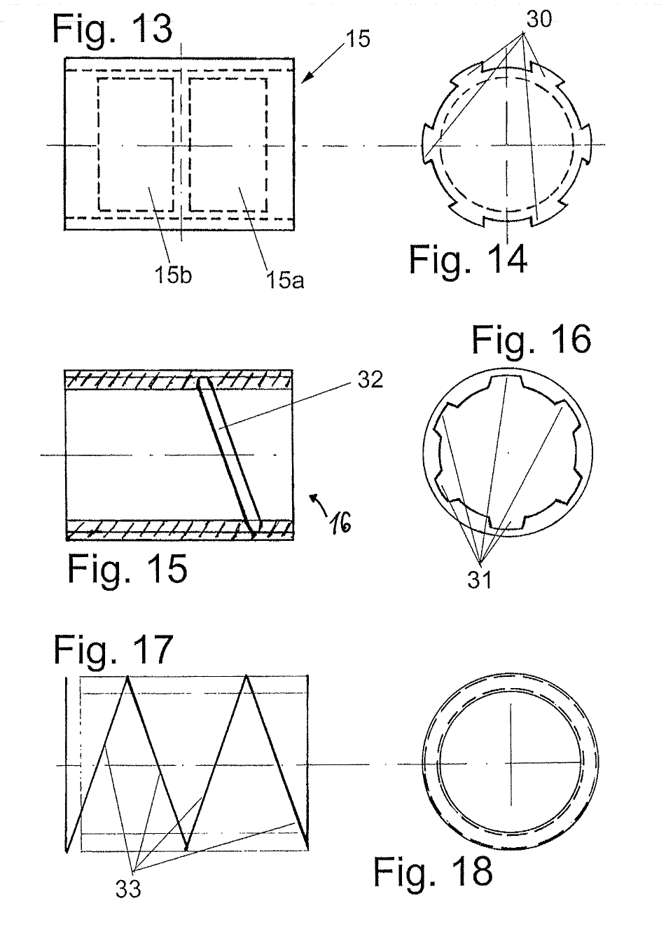

FIGS. 13 and 14 show a first embodiment of the crystal-colloid chamber 15. Crystal-colloid chamber 15 is formed as a double chamber and comprises the two chambers 15a and 15b. It is formed in a tubular manner, as shown in FIG. 14, and is provided on the outside with six segments 30, so that the water can flow through the intermediate spaces. The chamber 15a on the right in FIG. 13, which lies facing the permanent magnets 12, is filled with a colloidal medium, such as, for example, silver, while the chamber 15b, on the left in FIG. 13, which chamber 15b lies facing away from the permanent magnets 12, is filled with precious stones or similar minerals.

The tubular sleeve 16, as shown in FIGS. 15 and 16, serves for the water flow around the crystal-colloid chamber 15 and for its fixing. It is provided on the inside with six longitudinal grooves 31. Furthermore, the tubular sleeve 16 is provided with grooves 32 rotating to the right, which however are shown only in an indicative manner. As a result, the water flow flowing through is also conducted in a right-hand rotation around the crystal-colloid chamber 15.

A copper spring 33, as shown in FIGS. 17 and 18, serves for the water flow around the crystal-colloid chamber 15 and its fixing. Here too, right-hand rotation of the water flow is achieved.

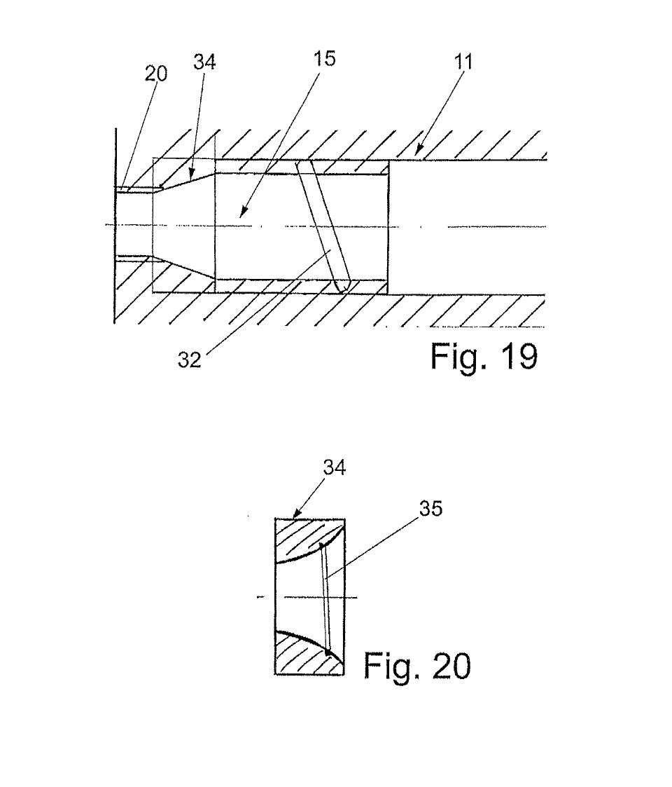

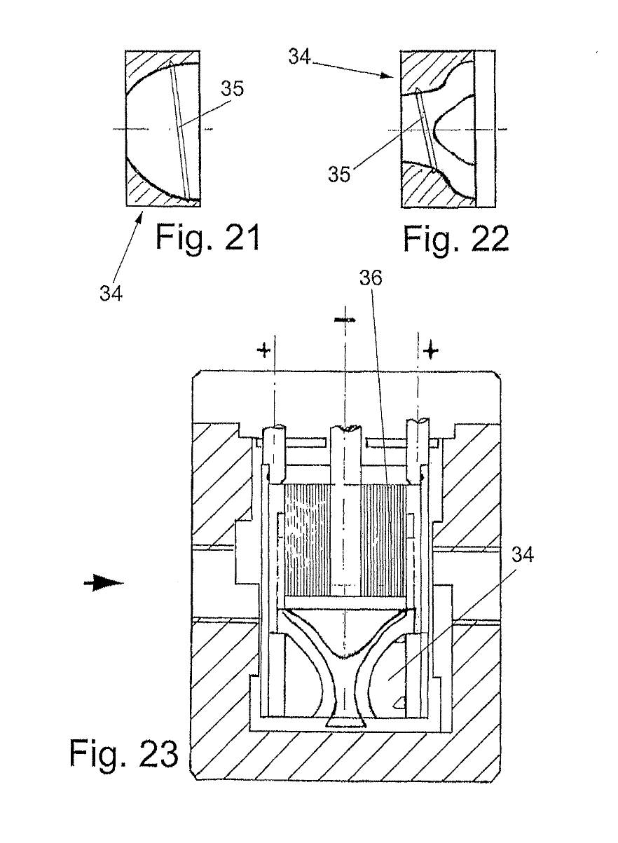

FIG. 19 shows that crystal-colloid chamber 15 adjoined by a conical region, which forms a funnel 34. Funnel 34 is shown in FIG. 19 as incorporated directly in the housing shell 11. In a way corresponding to that shown in FIGS. 20 to 22, funnel 34 may also be formed by a cylindrical insert, which is provided with a throughflow opening. As shown in FIG. 20, this throughflow opening is formed in the manner of a hyperbola and is also provided with further directing grooves 35. As shown in FIG. 21, this throughflow opening is formed in the manner of a sphere or hemisphere. The embodiment shown in FIG. 22 is in the form of a shaft. The funnel 34 makes an inwardly rolling vortexing motion of the water flow possible, which is further supported by the directing grooves 35.

FIGS. 23 to 25 show sterilizing modules, which may additionally be externally flange-mounted on the water connection 20 after the water purifier 10. According to the embodiment shown in FIG. 23, sterilizing module 36 is formed by a rolled-up silver mat, with a funnel 34, which funnel 34 includes a copper alloy, being arranged as a final stage, in a way similar to in the upstream water purifier 10. A current supply point is provided.

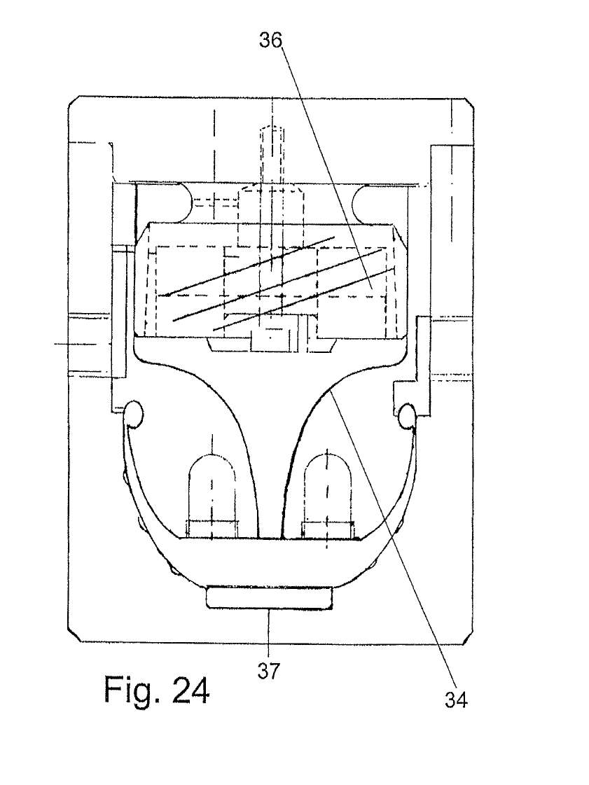

In the embodiment shown in FIG. 24, the water is first introduced tangentially in a direction predetermined by the form, rotating to the right over spiral grooves tapering in the manner of a multiple thread, outward into a funnel-shaped hyperbola. This produces the eddying effect of a cyclone. At the center of the housing cover there is a ring magnet, at the center of which a receiving disk is in turn arranged for the fixing of silver tubes. Attached underneath the outlet of the water flow, or outlet of the hyperbola funnel, is a disk-shaped plate made of a copper alloy. Extreme vortexing forces, such as cosmic energies, cause current to flow between the silver tubes and the copper plate. The process of natural electrolysis takes place. Silver and copper ions flow, germs are killed off The water now flows from the inside to the outside as a result of the geometrical shaping. A so-called levitated water motion takes place from the inner lower region upward and outward.

FIG. 25 also shows the sterilizing module 36 comprising a cluster of silver or copper tubes 38. The cluster, is for its part, located inside a larger copper or silver cylinder 39.

Although the present disclosure has been described and illustrated in detail, it is to be clearly understood that this is done by way of illustration and example only and is not to be taken by way of limitation. The scope of the present disclosure is to be limited only by the terms of the appended claims.

1-32. (canceled)

33. A physical water purifier comprising:
a tubular housing;
permanent magnets arranged at a specific distance from one another in the tubular housing in a region of the tubular housing facing a water connection, the permanent magnets being arranged so as to form a pumping and eddying effect; and
the permanent magnets are produced from an anisotropic magnetic material.

34. The physical water purifier as claimed in claim 33, wherein, to form turbulence, water baffle spacers are inserted between the permanent magnets, and further wherein the water baffle spacers are provided on an outer region with clearances.

35. The physical water purifier as claimed in claim 34, wherein the water baffle spacers, which define the specific distance separating the permanent magnets from one another, are arranged between the permanent magnets in the housing and each water baffle spacer is formed in the manner of a disk, an outer region of the disk being formed by segments, the widths of which segments are greater than a middle region.

36. The physical water purifier as claimed in claim 34, wherein, to form a water flow rotating to the right, each water baffle spacer is provided on an outer circumference with arcuately extending vanes, both from the inside outward and from the outside inward, the arrangement of the vanes corresponding to a natural pitch of a DNS spiral.

37. The physical water purifier as claimed in claim 34, wherein each water baffle spacer is provided in an outer region of its periphery with semicircular clearances, the outer region being provided with U-shaped clearances in which the spacers are inserted, and each spacer is provided in a middle region with a peripheral annular groove.

38. The physical water purifier as claimed in claim 34, wherein the water baffle spacers form an assembly, and individual water baffle spacers are at an acute angle in relation to one another.

39. The physical water purifier as claimed in claim 33, further comprising one or more glass disks inside the tubular housing, which glass disks include one or more of apertures and information symbols.

40. The physical water purifier as claimed in claim 34, wherein the water baffle spacers are made of corrosion-resistant materials from a group consisting of one or more of non-corrosive grades of stainless steel, nonferrous metals, gold, silver, sintered materials, plastics suitable for the injection molding process, and ceramics.

41. The physical water purifier as claimed in claim 33, wherein, adjoining the region having the permanent magnets, a crystal-colloid chamber is provided in the form of a double chamber, and a colloidal medium is introduced into a first chamber of the double chamber facing the permanent magnets, and precious stones are introduced into a second chamber of the double chamber facing away from the permanent magnets.

42. The physical water purifier as claimed in claim 41, wherein a region of the crystal-colloid chamber is surrounded by spiral grooves rotating to the right and the spiral grooves rotating to the right are provided on an inside of a sleeve, which sleeve is inserted into the tubular housing via the crystal-colloid chamber.)

43. The physical water purifier as claimed in claim 41, wherein the crystal-colloid chamber is followed by a funnel, which funnel is formed geometrically in the form of one of a cone, hyperbola, and sphere, and, for a rolling, vortexing motion of the water flow, the funnel is provided with directing grooves rotating to the right.)

44. The physical water purifier as claimed in claim 43, further comprising a sterilizing module flange-mounted after a run-out region located on an end of the funnel.)

45. The physical water purifier as claimed in claim 44, wherein the sterilizing module is formed by one of a copper and a silver mat and the run-out funnel has one of a silver and a copper coating on an inner surface.)

46. The physical water purifier as claimed in claim 44, wherein, by conducting the water in a specifically outward-to-inward hyperbolic manner, the sterilizing module produces a cyclone-like eddying effect in which there is a natural flow and in that a levitating water flow is produced from a inner lower region to an outer upper region and the pumping and eddying effect is achieved by the geometrical shaping that tapers from a bottom upward and ends in an opening oval form.

47. The physical water purifier of claim 33, further comprising one or more of precious stones and a colloidal medium arranged at a specific distance from one another in the tubular housing in a region of the tubular housing facing a water connection, the one or more precious stones and colloidal medium being arranged so as to form a pumping and eddying effect.

48. The physical water purifier of claim 33, wherein the permanent magnets include one or more of disk magnets, ring magnets and bar magnets.

49. The physical water purifier of claim 34, wherein the water baffle spacers are produced from a resistant material including one of brass and unplasticized polyvinylchloride.

50. The physical water purifier of claim 41, wherein the colloidal medium includes silver.

51. The physical water purifier of claim 41, wherein a region of the crystal-colloid chamber is surrounded by spiral grooves rotating to the right and the spiral grooves rotating to the right are incorporated directly on an inside of the tubular housing.

52. The physical water purifier of claim 44, wherein the sterilizing module includes a cluster of one of copper and silver tubes, which tubes are located inside one of a sliver and copper cylinder.
